(19) United States
(12) Patent Application Publication
(10) Pub. No.: US 2005/0160089 A1
(43) Pub. Date: Jul. 21, 2005

(54) Information extracting system and music extracting system

(75) Inventors: Teruhiko Fujita, Anjo-city (JP); Masatoshi Abou, Toyota-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/036,131

(22) Filed: Jan. 18, 2005

(30) Foreign Application Priority Data
Jan. 19, 2004 (JP) 2004-10958

(51) Int. Cl. G06F 7/00; G06F 17/30; A63H 5/00; G10H 7/00; G04B 13/00

(52) U.S. Cl. 707/3

(57) ABSTRACT

A music data storage medium stores, as well as multiple music compositions, a feature phrase database composed of data relating to respective feature phrases of the multiple music compositions. When a preview and reproduction process for a feature phrase is started, based on the feature phrase data, only the feature phrase of each of the music compositions is reproduced. The entire data of a music composition that a user prefers listening to is extracted from the music data storage medium by being selected when its feature phrase is reproduced; then, the entire music composition of the music composition is reproduced.

### CROSS REFERENCE TO RELATED APPLICATIONS

This application is based on and incorporates herein by reference Japanese Patent Application No. 2004-10958 filed on Jan. 19, 2004.

### FIELD OF THE INVENTION

The present invention relates to an information extracting system capable of effectively extracting preferred information when an information storage medium stores various information such as music compositions, music videos, movies, speeches (news, comic monologue, storytelling, or the like).

### BACKGROUND OF THE INVENTION

Patent Document 1 discloses a music introduction system that introduces main parts of music compositions stored in a storage medium. In this system, when a music introduction function control instruction is inputted in a playback mode, the point where the instruction is inputted is set as the music introduction start point. Further, the reproduction of the relevant music composition is continued until a given time period elapses from the music introduction start point.

At the ending point of the relevant music composition, it is determined whether the relevant music composition is the last one in the music compositions that should be reproduced. When it is the last one, the reproduction of the music compositions is stopped. In contrast, when it is not the last one, the next music composition is reproduced from the point corresponding to the music introduction start point in the preceding music composition. As the result, the subsequently reproduced music composition is not reproduced from the start point of the music composition, but reproduced after the time period corresponding to the previously set music introduction start point elapses.
Patent Document 1: JP-H6-20451 A (USP-5321674)

In a conventional music introduction system, a music introduction is performed such that the relevant music composition is reproduced from the start point for a given time period, so that only a prelude part of the music composition may be reproduced. After considering this, the above-disclosed system therefore provides a method where a user can arbitrarily set the music introduction start point.

However, in the above-disclosed system, when a music introduction start point is set to a certain music composition, the set music introduction start point is applied to the subsequent music compositions. Therefore, the subsequent music compositions cannot be always reproduced from the proper introduction start point that enables a user to grasp the contents of the relevant music composition. For instance, the lengths of the prelude parts of the music compositions are different from each other, while the respective entire lengths of the music compositions are different from each other. Therefore, the introduction start point that is recognized as a main part to a certain music composition is not always proper as the introduction start point of another music composition.

Thus, in the above-disclosed system or the conventional system, a main part of a music composition is not properly designated, so that the preferred information cannot be easily designated or extracted.

### SUMMARY OF THE INVENTION

It is an object of the present invention to provide an information extracting system and a music extracting system that enable preferred information to be accurately and effectively extracted by using a main part or a feature portion of information such as a music composition.

To achieve the above object, in a first aspect of the present invention, an information extracting system is provided with the following. An information storing unit is included for storing a plurality of information items. A feature data storing unit is included for storing feature data relating to feature portions with respect to the stored information items. An information specifying unit is included for specifying a preferred information item by using the feature data. Further, an information extracting unit is included for extracting data relating to the specified preferred information item, from the information items stored in the information storing unit.

In this structure, a feature data storing unit previously stores, as a database, feature data relating to a feature portion with respect to each of a music composition, a music video, a movie, a speech (news, comic monologue, storytelling, or the like). Only feature portions are stored as the database, so that a data volume of the feature data storing unit can be reduced. A user of this information extracting system accurately specifies the preferred information by reproducing the relevant feature portion based on the feature data, or by designating the search data corresponding to the relevant feature portion. Further, by extracting data relating to the specified information from the feature data storing unit, the data of the preferred information can be obtained.

In a second aspect of the present invention, a music extracting system is provided with the following. A music storing unit is included for storing music data of a plurality of music compositions. A feature storing unit is included for storing feature data relating to feature portions with respect to the stored music data of the music compositions. A music specifying unit is included for specifying a preferred music composition by using the feature data. Further, an extracting unit is included for extracting music data relating to the specified preferred music composition, from the music data of the music compositions stored in the music data storing unit.

In this structure, feature data relating to feature portions that represent features of respective music compositions is previously stored as a database. That is, the database that specifies the respective music compositions is composed of the feature data relating to the feature portions of the music compositions, so that a data amount of the database can be decreased. Further, the feature portions of the music compositions are apt to be easily memorized or recognized, so that the preferred music composition can be accurately specified using the feature data.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram showing an overall structure of a music reproduction device according to a first embodiment of the present invention;

FIG. 2 is a flow chart diagram showing a feature phrase preview and reproduction process according to the first embodiment;

FIG. 3 is a diagram showing an overall structure of a music purchase system according to a second embodiment of the present invention;

FIG. 4 is a block diagram showing an overall structure of an audio system in a vehicle according to the second embodiment;

FIG. 5 is a block diagram showing an overall structure of a music information center according to the second embodiment;

FIG. 6 is a flow chart diagram showing a feature phrase preview and purchasing process according to the second embodiment;

FIG. 7 is a block diagram showing an overall structure of a music reproduction device according to a third embodiment of the present invention; and

FIG. 8 is a flow chart diagram showing a feature phrase recognition and reproduction process according to the third embodiment.

### DETAILED DESCRIPTION OF THE PREFERRED EMBODIMENTS

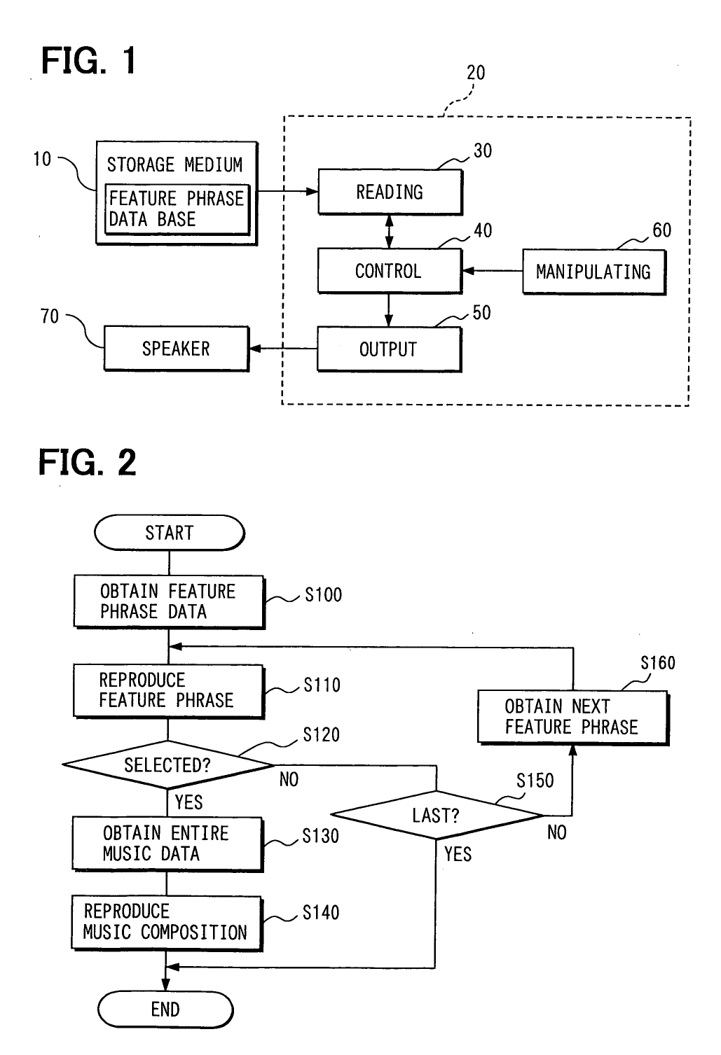

An information extracting system of a first embodiment of the present invention will be explained below. In the first embodiment, the information extracting system is directed to a music reproduction device whose structure is shown in FIG. 1. In this music reproduction device, music data that should be reproduced is extracted by using feature phrase data (to be explained later) of a music composition, and a corresponding music composition is reproduced based on the extracted music data. That is, the music reproduction device uses feature phrase data relating to each of feature phrases to thereby enable a preferred music composition to be effectively selected from the music compositions stored in a storage medium such as a compact disk (CD).

As shown in FIG. 1, the music reproduction device of this embodiment includes a music data storage medium 10 (e.g., CD) storing music data of multiple music compositions. The music data storage medium 10 stores a feature phrase database composed of feature phrase data relating to feature phrases of the multiple music compositions as well as the music data of the multiple music compositions.

This feature phrase data means music data corresponding to a feature phrase or feature portion that appeals to a user most preferably within a music composition. Note that the feature phrase data does not need to be composed of music data corresponding to the feature phrase. Otherwise, the feature phrase data can be composed of starting and ending time points of the feature phrases or physical or logical addresses of the feature phrases in the music data storage medium 10 where the feature phrases are stored. In this case, the music data of the feature phrase that is stored in the music data storage medium 10 is used in common for the feature phrase database, so that a data amount of the feature phrase database can be further decreased.

Further, of the music composition, a lyric (or words) or a melody can be separately used for the feature phrase data. The feature phrase is a portion that appeals to a listener most preferably, so that it can be easily memorized. Even only with a lyric or a melody, a preferred music composition can be sufficiently searched for.

Here, the feature phrase data is generated by a manufacturer or a dealer of the music data storage medium 10 storing music compositions, and is additionally stored in the music data storage medium 10. However, generating and providing of the feature phrase data does not need to be executed only by the manufacturer or the dealer. For instance, a database developer can generate a feature phrase database including music compositions including music compositions composed in past years to thereby distribute the feature phrase database as a pay service via a communications network or the like. In this case, the feature phrase database can be stored in a separate storage medium different from the music data storage medium 10. As long as music data stored in the music data storage medium 10 and feature phrase data in the feature phrase database are mutually associated with each other using identification information, storing orders, or the like, music date of a preferred music composition can be extracted by using feature phrase data. That is, suppose that feature phrases of the respective music compositions are reproduced by using the feature phrase data, and selection manipulating for selecting a preferred music composition is executed. In this case, as long as the feature phrase data and the music data are mutually associated, the music data corresponding to the selected feature phrase data can be specified and extracted.

As a specific database generating method, the following can be adopted. An operator listens to each music composition to thereby input a feature phrase of each music composition. Feature phrase data is automatically inputted by utilizing tonal scale variations in music compositions. Further, since a feature phrase is apt to be repeated in multiple times, the most repeated portion is automatically inputted as feature phrase data. Further, a music composition can contain not only one feature phrase, but also more than one feature phrase.

As shown in FIG. 1, the music reproduction device of the first embodiment includes a music signal processing unit 20 that reads out feature phrase data or music data stored as digital data in the music data storage medium 10, generates music signals as analog signals, and outputs them to a speaker 70.

In the music signal processing unit 20, a data reading unit 30 can have one of various structures depending on kinds of the music data storage medium 10. For instance, when the music data storage medium 10 is a CD, the data reading unit 30 includes a motor that rotates a CD and a light pick-up that reads data stored in the CD.

A control unit 40 gives an instruction relating to data that should be read out, to the data reading unit 30 while converting the data read from the data reading unit 30 to analog music signals to then output them to the music output unit 50. The music output unit 50 processes or amplifies the analog music signals outputted from the control unit 40 and then outputs the processed signals to the speaker 70. Thus, a music composition or a feature phrase stored in the music data storage medium 10 can be reproduced.

Further, in the music signal processing unit 20, a manipulating unit 60 includes various switches for reproducing a music composition, ending it, designating a music composition to be reproduced, and further gives instruction of executing a feature phrase preview mode where only a feature phrase is reproduced. The manipulating unit 60 can be provided within a body of the music signal processing unit 20, or provided as a remote controller.

Next, a feature phrase preview and reproduction process of a characteristic of this embodiment will be explained with reference to FIG. 2. In the feature phrase preview and reproduction process, using feature phrase data, a preferred music composition that a user wants to listen to is selected and reproduced. The feature phrase preview and reproduction process is executed when execution of the feature phrase preview mode is instructed by the manipulating unit 60.

At Step S100, music data corresponding to a feature phrase of the first music composition is obtained from within the multiple music compositions stored in the music data storage medium 10 of CD. That is, the control unit 40 gives to the data reading unit 30 an instruction for reading data in a region where music data corresponding to a feature phrase of the first music composition, and based on the instruction, the data reading unit 30 reads out the music data of the feature phrase of the first music composition. Here, when the music data itself, a lyric or a melody is stored as the feature phrase data, the feature phrase data is read out. In contrast, when the storing region of the music data of the feature phrase is stored, the music data in the designated region is read out.

At Step S110, based on the read music data of the feature phrase, the feature phrase is reproduced. At Step S120, it is determined whether the relevant music composition is selected by a user who listened to the reproduced feature phrase. Here, this user selects it to thereby listen to the entire music composition including the feature phrase. The presence or absence of the selection manipulating is determined by whether a selection manipulating signal is inputted or not. Here, in a case where a selection manipulating signal is not inputted before and when the reproduction of the feature phrase is completed, it is determined that selection manipulating is not present, which advances the process to Step S150.

At Step S150, it is determined whether the music composition whose feature phrase is reproduced is the last music composition within the music compositions stored in the music data storage medium 10. When it is determined that the music composition is determined to be not the last music composition, the process advances to Step S160. Here, the music data of the feature phrase of the next music composition is obtained based on the feature phrase data, which then returns the process to Step S110. In contrast, when it is determined that the music composition is determined to be the last music composition, the process is terminated since no more music composition whose feature phrase should be reproduced is present. In this case, otherwise, reproduction of the feature phrases can be re-started from the first music composition.

At Step S120, when the selection manipulating is determined to be present, the process advances to Step S130, where the entire music data of the selected music composition is obtained from the music data storage medium 10. Here, since the feature phrase data and the corresponding music data are associated with each other, the music data of the corresponding music composition is specified from the selected feature phrase data. The music data can be thereby extracted. At Step S140, based on the obtained music data, the music composition is reproduced from the start point.

Thus, in the music reproduction device of this embodiment, reproducing the feature phrases that feature the respective music compositions enables a preferred music composition to be selected, so that a user can securely and effectively select the preferred music composition.

### Second Embodiment

Next, a second embodiment will be explained below. In the second embodiment, a music extracting system is directed to a music purchase system. Here, a user listens to a feature phrase of a music composition to thereby determine whether the user wants to buy the music composition. When it is determined that the user wants to buy the music composition, the music data of the music composition corresponding to the feature phrase is obtained via a communications network. Thus, the user can effectively buy a preferred music composition by using feature phrase data.

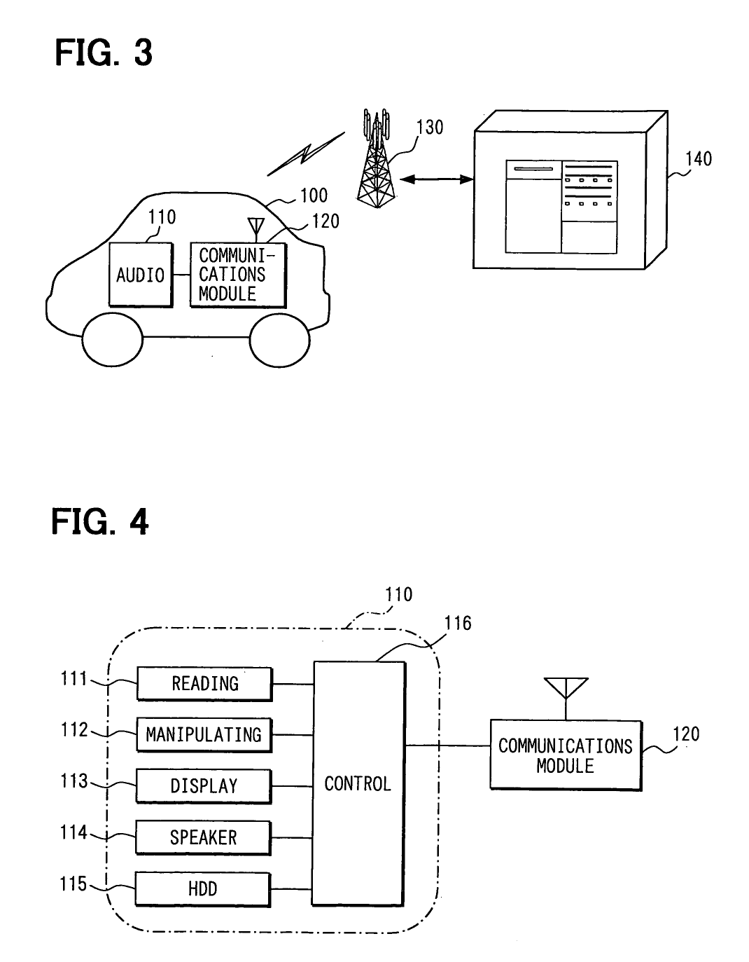

FIG. 3 shows an overall structure of the music purchase system of the second embodiment as an example. Here, a user has a vehicle 100 provided with an audio system 110 and a communications module 120, and buys a music composition via a communications network including an intermediary station 130, from a music information center 140 that stores a music database and a feature phrase database. However, the music purchase system of this embodiment can be directed not only to a vehicular application but also to a stationary home application, as long as a user possesses an audio system or the like in a stationary location such as an inside of a house to thereby communicate with the music purchase center 140.

As shown in FIG. 4, the audio system 110 includes a data reading unit 111, a manipulating unit 112, a display 113, a speaker 114, a hard disk drive (HDD) 115, and a control unit 116.

The data reading unit 111 reads data of a music composition or a video stored in a storage medium such as a CD, an MD, or a DVD and outputs it to the control unit 116. The manipulating unit 112 includes various switches for manipulating reproducing data stored in the storage medium, stopping reproduction of the data, and giving an instruction of purchase of music data by communications with the music information center 140. The manipulating unit 112 can be constructed of a remote controller, or use speech recognition for manipulating.

The display 113 is constructed of, e.g., a liquid crystal display, and shows a video when the video data is read by the data reading unit 111. The speaker 114 outputs sounds accompanying a music composition or a video. The HDD 115 has a hard disk as a storage medium where data is written or read. When music data that is purchased from the music information center 140 is received, the music data is stored in a hard disk by the HDD 115.

The control unit 116 gives to the data reading unit 111 an instruction of designating data to be read, generates video signals, music signals, or sound signals based on the data read by the data reading unit 111 to output them to the display 113 or the speaker 114. Further, the control unit 116 communicates with the music information center 140 via a communications module 120 and executes a music purchase process of receiving a preferred music composition by using feature phrase data. In the block diagram shown in FIG. 4, interfaces (e.g., music output unit) between the control unit 116 and connecting counterparts such as the speaker 114 are eliminated.

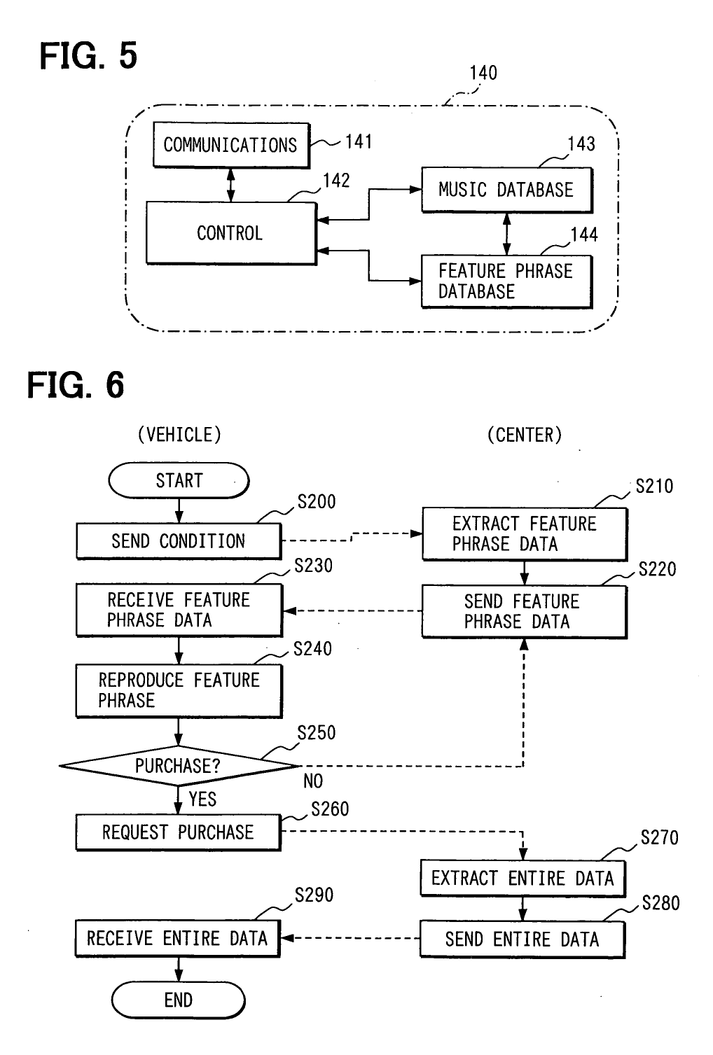

As shown in FIG. 5, the music information center 140 includes a communications unit communicating with the communications module 120 in the vehicle 100, a music database 143 composed of data of multiple music compositions, a feature phrase database 144 composed of feature phrase data relating to feature phrases of the music compositions stored in the music database 143, and a control unit 142 that receives conditions for narrowing down candidates for the music composition that the vehicle side wants to buy and sends to the vehicle 100 the music data and feature phrase data of the music composition that the vehicle side wants to buy.

In the music information center 140, the music database 143 and the feature phrase database 144 are classified into an album release and a single release. With respect to the album release, the respective music data is included as a unit of the music compositions included in the album. Further, the music data and the feature phrase data are preferably stored while being classified by a singer, a lyric writer, a melody writer, a genre, or a release date, so that the user who wants to buy a music composition easily searches for the preferred music composition.

Next, a feature phrase preview and purchasing process as a characteristic of the second embodiment will be explained below with reference to FIG. 6. In this process, a music composition that a user wants to buy is selected by using feature phrase data and the music data of the selected music composition is then obtained. The process is executed when a start switch for this process is manipulated by the manipulating unit 112. The left side of FIG. 6 is executed in the vehicle 100, while the right, in the music information center 140.

At Step S200, a narrowing-down condition for a music composition whose feature phrase is requested for being listened to is inputted by using the manipulating unit 112 and sent to the music information center 140. For instance, the preferred music composition can be effectively extracted by using the above singer, a melody writer, a lyric writer, a genre, a release date, or the like as the narrowing-down condition.

At Step S210, when the music information center 140 receives the narrowing-down condition, the feature phrase data of the feature phrase of the music composition matching with the narrowing-down condition is extracted. Here, when multiple music compositions match with the narrowing-down condition, the music data of the feature phrases of the multiple music compositions are extracted to be thereby sent to the vehicle 100 in order with respect to each music composition.

In the vehicle 100, at Step S230, the music data of the feature phrase is received. At Step S240, using the music data of the feature phrase, the feature phrase is reproduced. At Step S250, whether a user who previews the feature phrase wants to buy the relevant music data is determined by whether a purchase determining signal from the manipulating unit 112 is inputted. When a purchase determining signal is not inputted before and when the reproduction of the feature phrase is completed, a request for sending the music data of the feature phrase of the next music composition is sent to the music information center 140. When the music information center 140 receives the request, the music data of the feature phrase of the music composition that is previously extracted at Step S210 by matching with the narrowing-down condition is sent at Step S220. Here, when no music composition matching with the narrowing-down condition is present, an effect of no more music composition matching with the condition is sent to the vehicle 100.

In contrast, at Step S250, when it is determined that the user wants to buy the music data, the process advances to Step S260, where a purchase request signal with respect to the music composition having the previewed feature phrase is sent to the music information center 140. Based on the purchase request, in the music information center 140, at Step S270, the entire music data corresponding to the purchase-requested music composition is extracted from the music database 143. At Step S280, the extracted music data is sent to the vehicle 100. In the vehicle 100, at Step S290, the entire music data sent from the music information center 140 is received to be then stored in the hard disk, which terminates the purchase of the music composition.

Here, a payment method for a purchase price can adopt any known method like using a credit card or a pre-paid card. Regarding buying a music composition, a payment can be performed with respect to each music composition, or with respect to multiple music compositions. For instance, when a payment can be executed with respect to an album, usability can be enhanced for users.

As explained above, in the music purchase system of the second embodiment, a music composition that a user wants to buy is selected by using feature phrase data. Here, a feature phrase is a portion where a feature of each music composition is represented most remarkably, so that reproducing the feature phrase enables accurate recognition of a music composition that a user wants to buy. As a result, by using a feature phrase, a music composition that a user wants to buy can be effectively selected.

### Third Embodiment

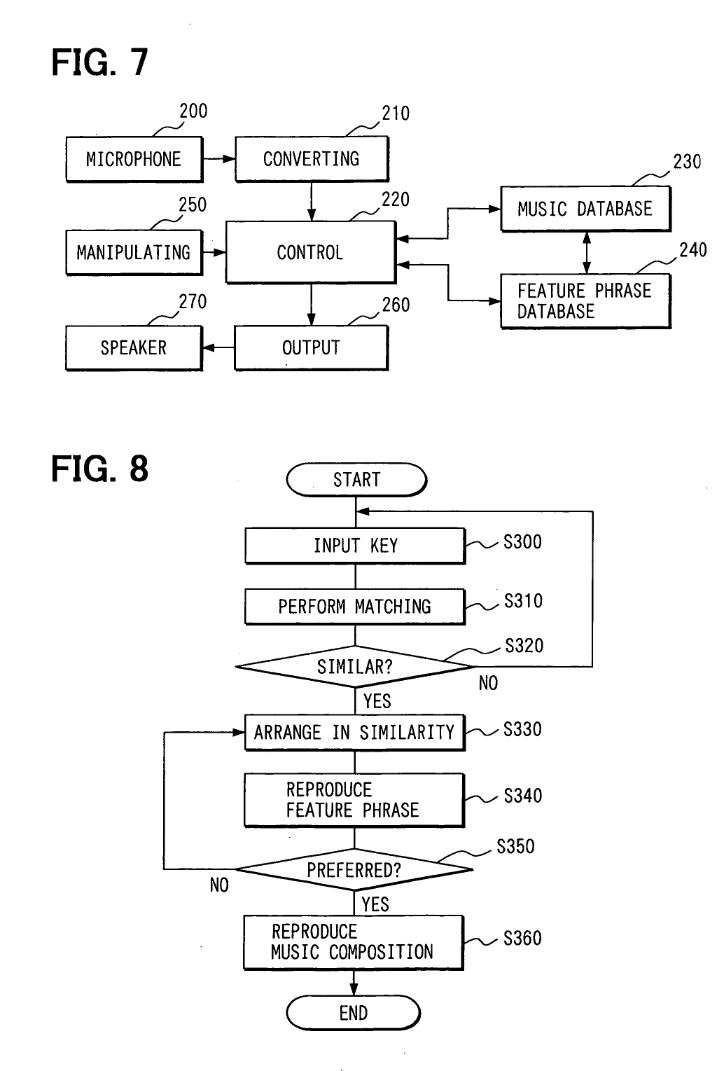

Next, a third embodiment will be explained below with reference to FIGS. 7, 8. In the third embodiment, a music extracting system is directed to a music reproduction device, similarly to the first embodiment. However, in the third embodiment, a user inputs a melody or a lyric (or words) of a feature phrase of a music composition that a user wants to be reproduced, which is different from the first embodiment. Then, feature phrase data of a feature phrase resembling the inputted melody or lyric is searched for, so that the music composition that the user wants to be reproduced is extracted. In the music reproduction device of the third embodiment, even when a user does not know a name of a music composition, a music composition to be reproduced can be selected as long as a feature phrase of the music composition is memorized. Therefore, this music reproduction device can be preferably used as a karaoke device or a sing-along machine.

As shown in FIG. 7, the music reproduction device includes a microphone 200 for a user to input a melody or a lyric of a music composition, and a sound converter 210. When a melody or a lyric is inputted from the microphone 200, the sound converter 210 converts an analog signal to a digital signal to then input it to a control unit 220. Here, the melody or the lyric inputted by the user can be a part or the whole of a feature phrase.

Also in the music reproduction device of the third embodiment, a music database 230 and a feature phrase database 220 are interfaced with the control unit 220, so that the control unit 220 can obtain music data or feature phrase data from these databases 230, 240.

When the melody or lyric converted to the digital signals is inputted to the control unit 220, the control unit 220 searches for feature phrase data having a feature phrase resembling the inputted melody or lyric. Based on the music data of the feature phrase, music signals are outputted to a speaker 270 via a music output unit 260. Thus, a feature phrase possibly including the inputted melody or lyric is reproduced.

When a user who previews the reproduced feature phrase determines that the reproduced feature phrase corresponds to a music composition the user prefers, this music composition is selected as a music composition to be reproduced by manipulating a manipulating unit 250. Here, through the manipulating unit 250, a start of selecting of a music composition using a melody or lyric of a feature phrase can be instructed.

Next, a feature phrase recognition and reproduction process will be explained with reference to FIG. 8. In this process, inputting a melody or lyric of a feature phrase leads to selecting and reproducing a preferred music composition.

At Step S300, a melody or lyric of a feature phrase that is a recognition key is inputted. That is, when a user gives an instruction of a start of selecting a music composition using a melody or lyric of a feature phrase through the manipulating unit 250, the control unit 220 enters a waiting state where input of a melody or lyric of a feature phrase is awaited. When a melody or lyric is inputted via the microphone 200 under the waiting state, the inputted data is stored as a recognition key.

Next, at Step S310, a matching process relating to sound or intonation is performed between the respective feature phrase data stored in the feature phrase database 240 and the recognition key (melody or lyric), to thereby compute a similarity degree. At Step S320, based on the similarity degree, a level of similarity between the recognition key and the respective feature phrase data is determined. Here, when the similarity degrees of entire feature phrase data are not more than a given value, the process returns to Step S300.

In contrast, at Step S320, when the similarity degree of any one of the feature phrase data is more than a given value, the process advances to Step S330. Here, the feature phrase data are arranged in an order of the similarity degrees. At Step S340, the feature phrases are reproduced in order from the highest similarity degree. Thereby, the user can quickly select a music composition that the user prefers.

By reproducing the feature phrase at Step S340, when the user recognizes that the reproduced feature phrase corresponds to the feature phrase of the preferred music composition, a selection manipulating signal is generated by manipulating the manipulating unit 250. At Step S350, it is determined whether the reproduced feature phrase corresponds to the preferred music composition based on a presence or absence of a selection manipulating signal. At Step S350, when it is determined that it does not correspond to the preferred music composition, the process returns to Step S330, where the feature phrase data of the next highest similarity degree is selected to be reproduced at Step S340. In contrast, when it is determined that it corresponds to the preferred music composition, the process advances to Step S360. Here, the music data corresponding to the reproduced feature phrase data is extracted from the music database 230, so that the preferred music composition is reproduced based on the extracted music data.

Thus, the music reproduction device of this embodiment causes a user to input a melody or lyric of a feature phrase. Based on the feature phrase data resembling the inputted melody or lyric, the music composition that the user prefers is extracted. Since a feature phrase of a music composition is easily memorized, a user often memorizes a feature phrase even if memorizing no name of the music composition. Even in this case, the music reproduction device of this embodiment can specify and then extract the music composition by using the feature phrase instead of the name of the music composition.

(Modification)

For instance, in the above embodiments, music compositions are information items as targets for extracting; however, music videos, movies, speeches (news, comic monologue, storytelling, or the like) can be also information items for extracting. For instance, with respect to movies, a preview or trailer can be a feature portion and constitute a feature phrase database. With respect to news, a headline can be a feature portion and constitute a feature phrase database. Thus, each of the above various information includes a feature portion, so that a feature phrase database for each of the various information can be composed of corresponding feature portions.

It will be obvious to those skilled in the art that various changes may be made in the above-described embodiments of the present invention. However, the scope of the present invention should be determined by the following claims.

1. An information extracting system comprising:
an information storing unit that stores a plurality of information items;
a feature data storing unit that stores feature data relating to feature portions with respect to the stored information items;
an information specifying unit that specifies a preferred information item by using the feature data; and
an information extracting unit that extracts data relating to the preferred information item specified by the information specifying unit, from the information items stored in the information storing unit.

2. The information extracting system of claim 1,
wherein the information specifying unit includes:
a feature reproducing unit that reproduces a feature portion by using the feature data; and
a selecting unit that selects the preferred information item when the feature portion is reproduced by the feature reproducing unit, and
wherein the extracting unit extracts entire data relating to the information item selected by the selecting unit, from the information items stored in the information storing unit.

3. The information extracting system of claim 1,
wherein the information specifying unit includes:
an inputting unit that inputs search data corresponding to at least a part of the preferred information item; and
a searching unit that searches for an information item including the inputted search data by referring to the feature data, and
wherein the extracting unit extracts entire data relating to the information item searched by the searching unit, from the information items stored in the information storing unit.

4. A music extracting system comprising:
a music storing unit that stores music data of a plurality of music compositions;
a feature storing unit that stores feature data relating to feature portions with respect to the stored music data of the music compositions;
a music specifying unit that specifies a preferred music composition by using the feature data; and
an extracting unit that extracts music data relating to the preferred music composition specified by the music specifying unit, from the music data of the music compositions stored in the music data storing unit.

5. The music extracting system of claim 4,
wherein the music specifying unit includes:
a feature reproducing unit that reproduces a feature portion by using the feature data; and
a selecting unit that selects the preferred music composition when the feature portion is reproduced by the feature reproducing unit, and
wherein the extracting unit extracts music data relating to the music composition selected by the selecting unit, from the music data of the music compositions stored in the music storing unit.

6. The music extracting system of claim 5, further comprising:
a music reproducing unit that reproduces the preferred music composition based on the extracted music data.

7. The music extracting system of claim 5, further comprising:
an obtaining unit that obtains the extracted music data by downloading the extracted music data via a communications network.

8. The music extracting system of claim 4,
wherein the music specifying unit includes:
an inputting unit that inputs at least one of a lyric and a melody corresponding to a feature portion of the preferred music composition; and
a searching unit that searches for a music composition including the inputted at least one of the lyric and the melody by referring to the feature data, and
wherein the extracting unit extracts music data relating to the music composition searched by the searching unit, from the music data of the music compositions stored in the music storing unit.

9. The music extracting system of claim 8, further comprising:
a music reproducing unit that reproduces the preferred music composition based on the extracted music data.

10. The music extracting system of claim 8, further comprising:
an obtaining unit that obtains the extracted music data by downloading the extracted music data via a communications network.

11. The music extracting system of claim 4,
wherein the feature data includes music data corresponding to each of the feature portions of the music compositions.

12. The music extracting system of claim 4,
wherein the feature data includes index data that designates a region where each of the feature portion is stored in the music storing unit.
